(19) United States
(12) Patent Application Publication
(10) Pub. No.: US 2007/0064274 A1
(43) Pub. Date: Mar. 22, 2007

(54) Image file managing device, facsimile device, image file managing method, image file managing computer program, and storage medium containing the program

(75) Inventor: Mitsuru Samejima, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/520,755

(22) Filed: Sep. 14, 2006

(30) Foreign Application Priority Data
Sep. 16, 2005 (JP) 2005-271232

(51) Int. Cl. H04N 1/00

(52) U.S. Cl. 358/403; 358/1.15

(57) ABSTRACT

An image file managing device of the present invention manages image files stored in a memory section. Each image file contains image data and comment data. The device includes a check determining section, which determines whether an image in the image data has been checked by the user; and a check information recording section which records as additional information, in the comment data, check information indicative of whether the image has been checked by the user based on a determination made by the check determining section.

This nonprovisional application claims priority under 35 U.S.C. §119(a) on Patent Application No. 2005-271232 filed in Japan on Sep. 16, 2005, the entire contents which are hereby incorporated by reference.

### FIELD OF THE INVENTION

The present invention relates in general to an image file managing device for managing image files, and an associated facsimile device, image file managing method, image file managing computer program, and storage medium containing the program, and in particular to image file management in an information communications terminal, such as a facsimile device and a personal computer.

### BACKGROUND OF THE INVENTION

High convenience facsimile devices, which transmit/receive image data, are conventionally known. They add supplemental information, such as comments on the image and application data, to an image file before being transmitted. On the receiving end, the machine reads the information on the image data added on the transmitting end, to readily and correctly print or displays the received image data.

Such a high convenience facsimile device is disclosed in Japanese Unexamined Patent Publication 8-317114/1996 (Tokukaihei 8-317114; published on Nov. 29, 1996). The transmitting end adds supplemental information to an image file in a standardized JPEG (Joint Photographic Experts Group) format, for example, to indicate whether the file contains a character code. The receiving-end facsimile device extracts and prints the supplemental information from a comment marker, an application marker, etc. in the image file, enabling the user to readily obtain the supplemental information.

Japanese Unexamined Patent Publication (Tokukai 2000-92301; published on Mar. 31, 2000) discloses another facsimile device. The transmitting-end device reads image data from an original to be transmitted. For each page of the original, the device adds supplemental information to the outgoing image data before being transmitted. The supplemental information includes a document number indicating a transmission unit of the original document, the page number of the original, front side/back side information for the original, and associated page information. By using the supplemental information, the receiving end can produce a facsimile of the original in the same page arrangement as the original.

Japanese Unexamined Patent Publication (Tokukai 2003-101681; published on Apr. 4, 2003) discloses a high functionality facsimile device. The transmitting end produces scaled-down image data, or thumbnail data, to insert the data in a comment marker of an image file in a standardized JPEG format. Thus, the thumbnail data is added to the image file and transmitted as supplemental information for the image data. The thumbnail data is displayed on the receiving end so that the user can quickly check the content of the received image data and output necessary images alone.

The Tokukaihei 8-317114 facsimile device prints the supplemental information added to the outgoing image file on the transmitting end. The user on the receiving end can check that information, such as comments on the image and application data. The image file however does not contain any information as to whether the user has viewed the image data.

The Tokukai 2000-92301 facsimile device adds supplemental information as to the front side/back side of the original to the image file before being transmitted. The receiving end can store the supplemental information together with the image data. In addition, the receiving end can produce a facsimile of the original in the same page arrangement as the original based on the supplemental information. The information stored on the receiving end, however, is mere front side/back side information for the original. Again, the image file does not contain any information as to whether the user has viewed the image information.

The Tokukai 2003-101681 facsimile device adds thumbnail data as supplemental information to the image file before a transmission, enabling the user on the receiving end to quickly check the content and output necessary images alone. Nevertheless, the image file again does not contain any information as to whether the user has viewed the image information.

If the user forgets to erase the received image data, which he/she has viewed, many image files remain stored in a memory section without being erased, and the memory section becomes full and the device can receive no more incoming data.

To address this problem, the user should from time to time erase the received image data, which has been checked and has become no longer necessary. On conventional facsimile devices, the received image data contains no information as to whether the user has viewed the received image data. The user needs to take trouble to check whether he/she has viewed particular pieces of received image data. The user cannot easily erase the received image files, which he/she has viewed, and are no longer necessary.

### SUMMARY OF THE INVENTION

The present invention has an objective to provide an image file managing device, etc. which offers added convenience in image file management.

In order to achieve the above objective, the image file managing device in accordance with the present invention, which manages image files stored in the memory section, each of the image files containing image data and comment data, is characterized by including: check determining section which determines whether an image in the image data has been checked by the user; and check information recording section which records as additional information in the comment data, check information indicative of whether the image has been checked by the user, based on a determination made by the check determining section.

According to the foregoing structure, the information recording section records as additional information, check information indicative of whether the image has been checked by the user in the comment data of the image file based on a determination made by the check determining section. Accordingly, the image files alone, without a dedicated file for the check information, enables a determination as to whether the particular image has been checked by the user. This eliminates the problem of an increase in the data amount caused by a dedicated file to be prepared for management information.

The image file managing device in accordance with the present invention is especially suitable for use when, for example, the image files as received are copied or transferred to an information communications terminal other than the image file managing device (personal computer, one of various storage media, etc.) for management.

By recording the check information within each image file, it is possible to manage the check information and the image data in a single file. This eliminates the need for the management, etc. of links between the image files and the check information (which would be essential if the check information was managed as a standalone file separated from the image files) even when the image files are transferred to an information communications terminal other than the image file managing device in accordance with the present invention for management. As a result, the image files can be managed in more efficient manner.

In order to achieve the above objective, the facsimile device in accordance with the present invention is characterized by including: image receiver section which receives image files transmitted by facsimile; and an image file management device in accordance with the present invention which manages the image files received by the image receiver section.

According to the foregoing structure, the facsimile device includes an image file managing device which manages image files received by the image receiver section transmitted by facsimile and stored in the memory section, each image file containing image data and comment data. The image file managing device includes: a check determining section which determines whether an image in the image data has been checked by the user; and an information recording section which records as additional information in the comment data, check information indicative of whether the image has been checked by the user, based on a determination made by the check determining section.

Accordingly, the image file alone, without a dedicated file for the check information, enables a determination as to whether the user has checked particular images. This eliminates the problem of an increase in the data amount caused by a dedicated file to be prepared for management information.

The facsimile device in accordance with the present invention is suitable for use even when, for example, the image files received by the facsimile device including the image file managing device in accordance with the present invention are copied, moved, or otherwise transferred to an information communications terminal other than the image file managing device (personal computer, one of various storage media, etc.) for management.

By recording the check information within each image file, it is possible to manage the check information and the image data in a single file. This eliminates the need for the management, etc. of links between the image files and the check information (which would be essential if the check information was managed as a standalone file separated from the image files) even when the image files are transferred to an information communications terminal other than the image file managing device in accordance with the present invention for management. As a result, the image files can be managed in more efficient manner.

The image file managing method in accordance with the present invention, to achieve the objective, is characterized in that it is a method of managing image files stored in a memory section, each image file containing image data and comment data, the method including the steps of: (1) determining whether a user has checked an image reproduced from the image data; and (2) recording check information as additional information in the comment data, check information indicative of whether the image has been checked by the user, based on a determination made in the step (1).

According to the method, the image files alone, without a dedicated file for the check information, enables a determination as to whether particular image(s) has (have) been checked by the user. This eliminates the problem of an increase in the data amount caused by a dedicated file to be prepared for management information.

The image file managing device in accordance with the present invention is especially suitable for use when, for example, the image files as received are copied or transferred to an information communications terminal other than the image file managing device (personal computer, one of various storage media, etc.) for management.

By recording the check information within each image file, it is possible to manage the check information and the image data in a single file. This eliminates the need for the management, etc. of links between the image files and the check information (which would be essential if the check information was managed as a standalone file separated from the image files) even when the image files are transferred to an information communications terminal other than the image file managing device in accordance with the present invention for management. As a result, the image files can be managed in more efficient manner.

The image file managing device may be implemented on a computer. When this is a case, the present invention encompasses a computer program for image file management, causing the computer to function as the respective sections in the image file managing device to implement the image file managing device on the computer; and a computer-readable storage medium containing the computer program.

The following description will discuss the present invention further in detail by way of examples and comparative examples, which by no means limit the scope of the present invention. The characteristics of the water absorbing resin were measured in the methods detailed below.

### BRIEF DESCRIPTION OF THE DRAWINGS

FIG. 1 is a block diagram illustrating the configuration of major parts of a facsimile device in accordance with an embodiment of the present invention.

FIG. 2 is an illustration of image files, as an example, stored in a memory section in the facsimile device.

FIG. 3 is an illustration of a display list, as an example, of check information contained in comment data for the image files.

FIG. 4 is a flow chart illustrating the process of storing the check information in the facsimile device.

FIG. 5 is a flow chart illustrating the process of notifying a user of the check information in the facsimile device.

FIG. 6 is a flow chart illustrating the batch process of erasing image files in the facsimile device.

### DESCRIPTION OF THE EMBODIMENTS

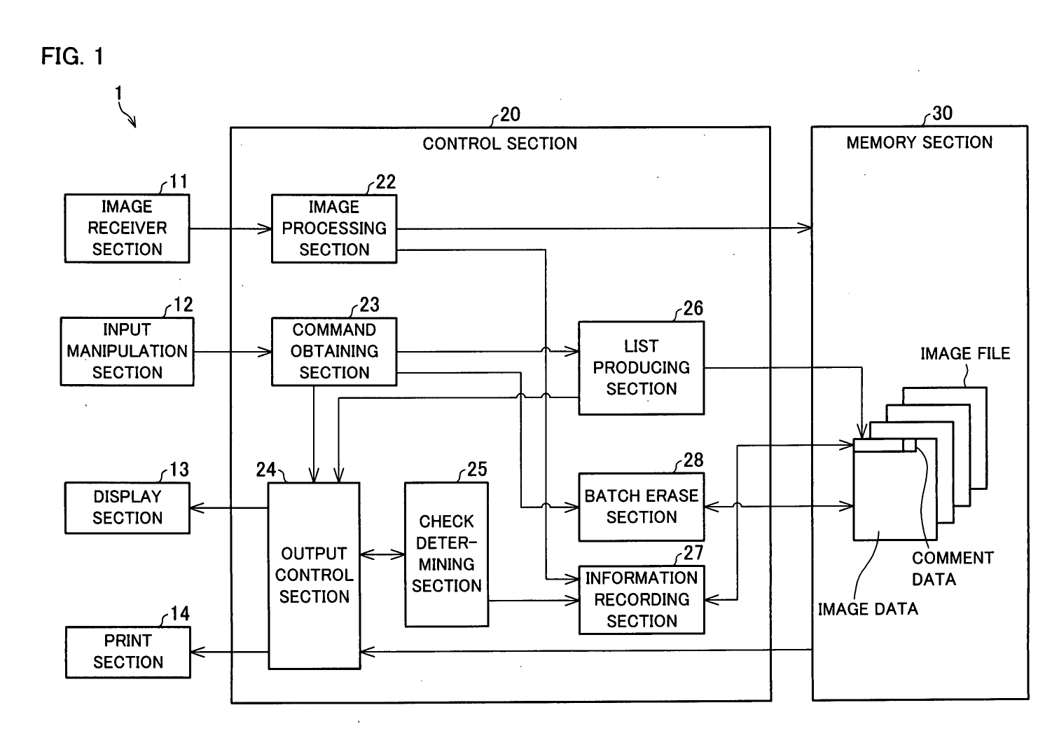

The following will describe an embodiment of the present invention in reference to FIGS. 1 to 6. FIG. 1 is a block diagram illustrating the structure of a facsimile device 1 in accordance with the present embodiment.

Referring to FIG. 1, the facsimile device 1 of the present embodiment includes a control section (image file managing device) 20, an image receiver section 11, an input manipulation section 12, a display section (notification means, display means) 13, a print section (notification means, print means) 14, and a memory section (storage means) 30.

The control section 20 controls the overall operation of the facsimile device 1. The control section 20 is made up of, for example, a CPU (Central Processing Unit) or an MPU (Micro Processing Unit) and executes control programs from program memory. The control section 20 will be explained later in detail.

The image receiver section 1 1 receives an image file transmitted from a transmitting end by facsimile.

The input manipulation section 12 receives user inputs to enable/disable various settings. The input manipulation section 12 may include a group of ten keys and function keys provided on the main body of the facsimile device, scroll/shift keys, and a touch panel on the screen of the display section 13.

The display section 13, under the display control of an output control section 24 (detailed later), displays received images, check information, and guidance to the user. The display section 13 of the facsimile device 1 is desirably a color LCD (Liquid Crystal Display) with such a large number of pixels and a wide display that a list of thumbnail images can be displayed together. The display section 13 may be a PDP (Plasma Display Panel) or an EL (Electroluminescence) display.

The print section 14 prints out received images and check information under the print control of the output control section 24.

The memory section 30 contains a RAM, a hard disk drive (HDD), or like storage device. The memory section 30 stores therein software for the operation of the control section 20, various data, such as the received image files, and various computer programs.

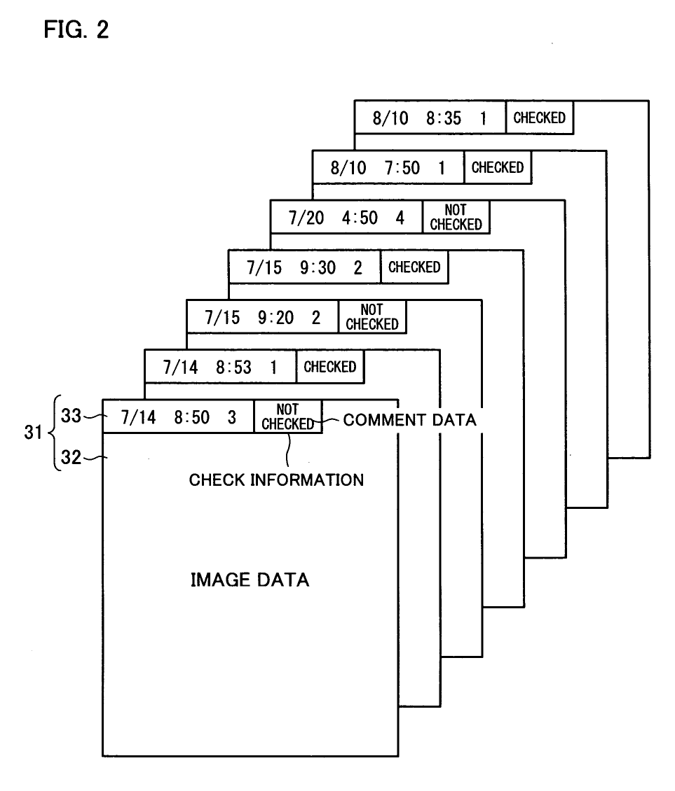

FIG. 2 shows an example of image files stored in the memory section 30 in the present embodiment. As shown in FIG. 2, the image file 31 contains image data 32 and comment data 33. The comment data 33 is made up of reception information and check information (detailed later).

Now, the control section 20 will be described in detail. Referring back to FIG. 1, the control section 20 includes an image processing section 22, a command obtaining section 23, an output control section 24, a check determining section (check determining means) 25, a list producing section 26, an information recording section (check information recording means) 27, and a batch erase section (batch erase means) 28.

The image processing section 22 decodes facsimile signals encoded at the transmitting end and received by the image receiver section 11 to be converted into a received digital image file 31 containing comment data 33 in a JPEG, TIFF, GIF, or like format.

The command obtaining section 23 receives various commands via user manipulation of the input manipulation section 12. In addition, the command obtaining section 23 transfers the various commands to the output control section 24, the list producing section 26, the batch erase section (batch erase means) 28, etc.

The check determining section 25 determines whether the user has checked a particular received image. The check determining section 25 makes a decision in accordance with various sets of user specifications.

For example, if the received image files contain thumbnail data, or scaled-down image data, a list of the thumbnails for the received image data is displayed on the display section 13 when a thumbnail display button on the screen of the display section 13 is pressed through the touch panel. The check determining section 25 may be set up to determine that an image has been checked by the user when the image is selected from the list of thumbnails, and is displayed in a larger scale. Alternatively, the section 25 may be set up to so determine when the thumbnail is displayed.

The check determining section 25 may be set up in this manner so that the section 25, when there is an image display output instruction from the output control section 24 to the display section 13, determines that the image has been checked by the user. Similarly, the check determining section 25 may be set up so that the section 25, when there is an image print output instruction from the output control section 24 to the print section 14, determines that the image has been checked by the user.

Generally, the user checks an image by looking at a displayed or printed image. Therefore, if the check determining section 25 is set up in the foregoing manner so that it determines, when the image data is displayed or printed, that the user has checked the image, it can be appropriately determined whether the user has checked the image.

The information recording section 27 records the reception date and time, the number of sheets received, and other reception information as part of the comment data 33 in the image file 31 received by the image receiver section 11 and stored in the memory section 30. In addition, the information recording section 27 records as additional information to the reception information in the comment data 33, check information indicative of whether the image has been checked by the user.

The list producing section 26, upon receiving a check information display command from the user, produces a list of the check information of the image files 31 stored in the memory section 30. The list produced by the list producing section 26 is sent to the output control section 24 to produce a display on the display section 13 or to produce a printout on the print section 14.

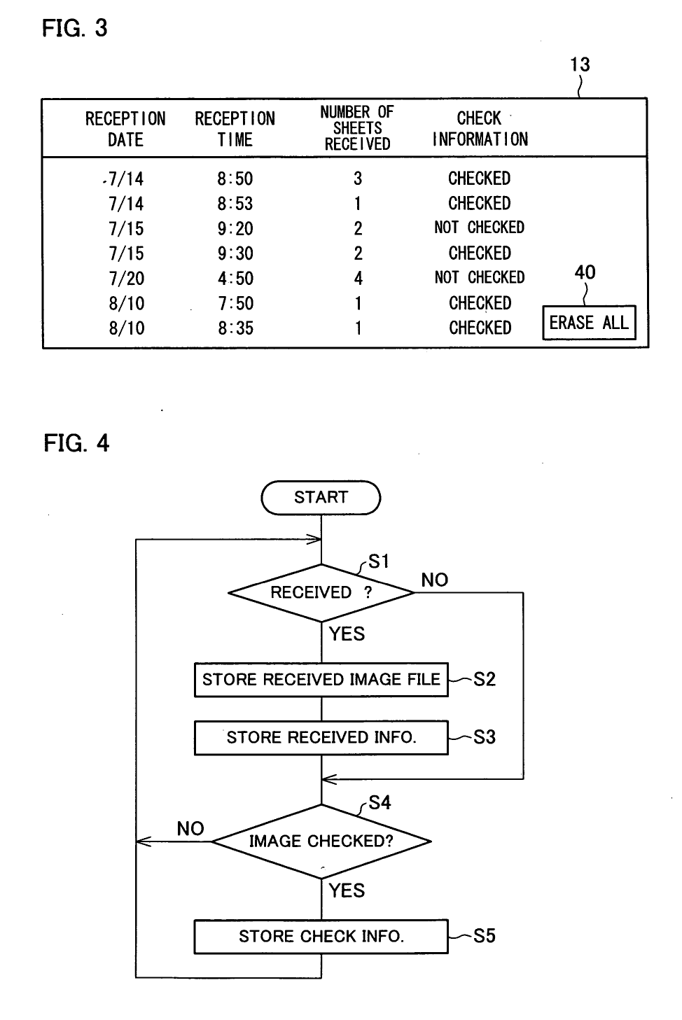

FIG. 3 shows an example of the list of check information displayed on the display section 13. For each image file 31, the list shows check information indicative of whether the image in the image file 31 has been checked by the user, along with the reception information of the image file 31 (a reception date, a reception time, and the number of sheets received).

Specifically, “Checked” appears for an image file 31 for which the information recording section 27 has recorded check information indicating that the image in each image file 31 has been checked by the user. Meanwhile, “Not Checked” appears for an image file 31 for which the information recording section 27 has not recorded the check information.

The check information recording section 28 erases, from the memory section 30, all the image files 31 for which the check information (information indicating that their images have been checked by the user) is stored.

Next, a process of storing the check information in accordance with the present embodiment will be described in reference to the flow chart in FIG. 4. FIG. 4 shows the process of storing the check information in the facsimile device 1 having the foregoing structure.

As shown in the flow chart in FIG. 4, first, it is determined whether the image receiver section 11 has received an image file 31 (step 1). If no image file 31 has been received (NO in step 1), the process continues at step 4.

In contrast, if an image file 31 has been received (YES in step 1), the image processing section 22 decodes and otherwise processes the file and stores the received image file 31 in the memory section 30 (step 2). Next, the information recording section 27 stores the reception date and time, the number of sheets received, and other reception information in the comment data (comment marker in the case of a JPEG format) 33 of the mage file stored in the memory section 30 (step 3).

Next, the check determining section 25 determines whether the user has checked the image in the image file 31 stored in the memory section 30 (step 4). If the user has not checked the image (NO in step 4), the process returns to step 1 where the operation is repeated.

In contrast, if the image has been checked by the user, the information recording section 27 records check information indicating that the image in the image file 31 has been checked by the user as part of the comment data 33 of the image file 31 (step 5). Thereafter, the process returns to step 1 and the foregoing operation is repeated.

With the foregoing structure, by recording the check information in the image file 31, it is possible to manage the check information and the image data 32 in a single file. This eliminates the need for the management, etc. of links between the image files 31 and the check information (which would be essential if the check information was managed as a standalone file separated from the image files) even when the image files are transferred to an information communications terminal other than the facsimile device 1 of the present embodiment (personal computer, mobile phone/PHS (registered trademark) (Personal Handy-Phone System), mobile information terminal (PDA (Personal Digital Assistants), etc.) or one of various storage media) for management. As a result, the image files 31 can be managed in more efficient manner.

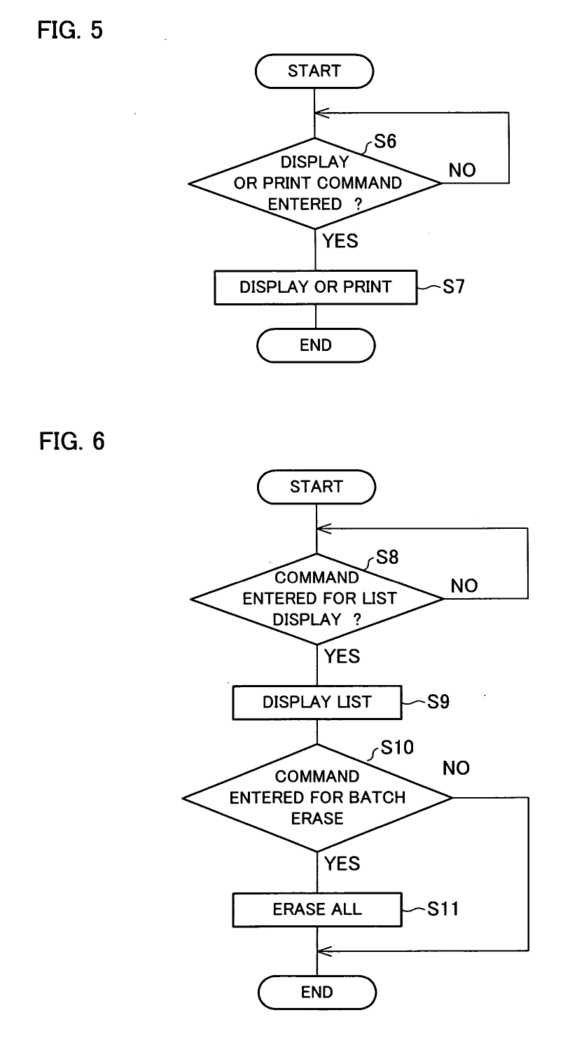

Next, a process of notifying the user of the check information in the present embodiment will be described in reference to the flow chart in FIG. 5. FIG. 5 shows the process of notifying the user of the check information in the facsimile device 1.

As shown in the flow chart in FIG. 5, first, the device 1 stands by until the command obtaining section 23 obtains a display instruction or a print instruction for the check information (step 6). Upon obtaining a display instruction or a print instruction (YES in step 6), the check information is displayed or printed (step 7), followed by the termination of the process.

In this manner, the user is notified of whether the image in the image file has been checked by the user through a display or a printout based on the check information from which it can be determined whether the image has been checked by the user. Thus, the user can easily recognize the existence of unnecessary, checked image files.

As a result, the user is prompted to erase the unnecessary, checked image files. This prevents the problem that the user forgets to erase the unnecessary image files and leaves too many image files in the memory section without being erased to receive additional incoming data.

Next, a batch process of erasing image files in accordance with the present embodiment will be described in reference to the flow chart in FIG. 6. FIG. 6 shows the batch process of erasing image files 31 in the facsimile device 1.

As shown in the flow chart in FIG. 6, first, the device stands by until the command obtaining section 23 obtains a command to display a list of the check information for the image files 31 stored in the memory section 30 (step 8).

Upon receiving a command to display such a list, the list producing section 26 produces a list of check information for the image files 31. The produced list is displayed on the display section 13 under the control of the output control section 24 (step 9).

Next, the command obtaining section 23 determines whether the user has issued a batch erase command for erasing from the list as displayed the image files 31 which contain the check information indicative of that the image in each image file 31 has been checked by the user (step 10). If there has been issued no batch erase command (NO in step 10), the process is terminated without carrying out any further operation. In contrast, if a batch erase command has been issued, the image files 31 which contain the check information indicative of that the respective images in the image files 31 have been checked are erased at once (step 11).

As described, it is preferable that the facsimile machine 1 be provided with the batch erase section 28 which extracts the check information from the image files 31 stored in the memory section 30 and carries out the batch process of erasing from the memory section 30, all the image files 31 containing the check information indicative of that the respective images has been checked by the user.

With the foregoing structure, the user can easily erase from the memory section 30, the image files 31 which have been checked and have become no longer necessary to be stored by a simple input operation, for example, pressing an erase all key 40 (FIG. 3) provided on a touch panel over the screen of the display section 13. This prevents, in a more reliable manner, the problem that the user forgets to erase the unnecessary image files 31 and leaves too many image files 31 in the memory section 30 without being erased, to receive additional incoming data.

The present invention is not limited to the description of the embodiments above, but may be altered by a skilled person within the scope of the claims. An embodiment based on a proper combination of technical means disclosed in different embodiments is encompassed in the technical scope of the present invention.

For example, the image file of the present invention may be of any format or type as long as the image file contains comment data in a JPEG, TIFF, GIF, or like format.

The present invention may be arranged as in the following.

A facsimile device in accordance with the present invention which transmits and receives image data may be arranged so as to include a recording section which records as addition information, management information from which it can be determined whether the image in the image file as received has been checked by the user; and a memory section which stores the management information, to facilitate the management of unchecked images.

The facsimile device having the foregoing structure may be characterized in that the management information is prepared by inserting the information indicative of that the image has been checked by the user into a comment addition region in the image data.

The facsimile device having the foregoing structure may be provided with display section which displays management information in which check information indicative of that the image of the image file as received has been checked by the user is recorded as additional information by the recording section.

The facsimile device having the foregoing structure may be provided with the function of erasing all the image files whose images have been checked at once based on the check information in addition to the function of informing the user of the existence of unchecked images based on the check information.

It is preferable that the facsimile device be arranged so as to be capable of managing the check information in the image files, without having to store the management information in a dedicated file.

Finally, all the blocks in the facsimile device 1 (the control section 20 in particular) may be provided in the form of hardware or in the form of software by using a CPU as follows.

The facsimile device 1 includes a CPU (central processing unit) and memory devices (memory media). The CPU (central processing unit) executes instructions in control programs realizing the functions. The memory devices include a ROM (read only memory) which contains computer programs, a RAM (random access memory) to which the programs are loaded, and a memory containing the programs and various data. The objective of the present invention can also be achieved by mounting to the facsimile device 1 a computer-readable storage medium containing control program code (executable program, intermediate code program, or source program) for the facsimile device 1, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disc, such as CD-ROM/MO/MD/DVD/CD-R; a card, such as an IC card (memory card) or an optical card; or a semiconductor memory, such as a mask ROM/EPROM/EEPROM/flash ROM.

The facsimile device may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, electric power line, cable TV line, telephone line, or ADSL; or wireless, such as infrared radiation (IrDA, remote control), Bluetooth (registered trademark), 802.11 wireless, HDR, mobile telephone network, satellite line, or terrestrial digital network. The present invention encompasses a carrier wave or data signal transmission in which the program code is embodied electronically.

As described in the foregoing, the image file managing device in accordance with the present invention is characterized in that it is an image file managing device which manages image files stored in a memory section (storage means), each image file containing image data and comment data and includes: a check determining section (check determining means) which determines whether an image in the image data has been checked by a user; and information recording section (check information recording means) which records as additional information in the comment data, check information indicative of whether the image has been checked by the user based on a determination made by the check determining section.

According to the foregoing structure, the information recording section records as additional information check information indicative of whether the image has been checked by the user to the comment data of the image file based on the determination made by the check determining section. Accordingly, the image file alone, without a dedicated file for the check information, enables a determination as to whether the particular image has been checked by the user. This eliminates the problem of an increase in the data amount caused by a dedicated file to be prepared for management information.

The image file managing device in accordance with the present invention is especially suitable for use when, for example, the image files as received are copied or transferred to an information communications terminal other than the image file managing device (personal computer, one of various storage media, etc.) for management.

Recording the check information in each image file enables integral management of the check information and the image data as a single file. This eliminates the need for management, etc. of links between the image files and the check information (which would be essential if the check information was managed as a standalone file separate from the image files) even when the image files are transferred to an information communications terminal other than the image file managing device in accordance with the present invention for management. As a result, improved convenience can be realized in the management of the image files.

The image file of the present invention may be of any format or type as long as the image file contains comment data (comment marker in the case of a JPEG format) in a JPEG (Joint Photographic Experts Group), TIFF (Tagged Image File Format), GIF (Graphics Interchange Format), or like format.

The image file managing device having the foregoing structure may be arranged so as to further include a display section (display means) which displays information, wherein when the display section displays the image in the image data, the check determining section determines that the image in the image data has been checked by the user.

Furthermore, the image file managing device may be arranged so as to further include a print section (print means) which prints out information, wherein when the print section prints out the image in the image data, the check determining section determines that the image in the image data has been checked.

Generally, the user checks an image by looking at a displayed or printed image. Therefore, if the check determining section is set up to determine, when the display section prints or the print section prints the image reproduced from the image data, that the image reproduced from the image data has been checked, it can be determined in a suitable manner whether the image has been checked by the user. Accordingly, for example, in response to a determination made by the check determining section when the image is displayed or printed, the information recording section records the check information indicating that the image has been checked. The check information thereby allows a suitable determination as to whether the image(s) has (have) been checked by the user.

The image file managing device having the foregoing structure of the present invention may be arranged so as to further include a notification section, which extracts the check information from each image file to notify the user of whether the image in each image file has been checked by the user based on the check information.

According to the foregoing structure, the user is notified of whether the image in each image file has been checked based on the check information. Thereby, the user can easily recognize the existence of unnecessary, checked image files in the memory section.

As a result, the user is prompted to erase the unnecessary, checked image files. This prevents the problem that the user forgets to erase the unnecessary image files and leaves too many image files in the memory section without being erased, to receive additional incoming data.

The image file managing device having the foregoing structure may be arranged so as to further include a display section, which displays information, wherein the notification section notifies the user of whether the image in each image file has been checked by displaying the check information on the display section.

The image file managing device in accordance with the present invention having the foregoing structure may be arranged so as to include a print section, which prints out information, wherein the notification section notifies the user of whether the image in each image file has been checked by printing out the check information.

The image file managing device in accordance with the present invention having the foregoing structure may be characterized so as to further include a check information recording section (batch erase means) which extracts the check information from each of the image files stored in the memory section and carries out a batch process of erasing from the memory section, all the image files containing images already checked by the user, based on the check information.

According to the foregoing structure, the check information recording section has the function of erasing all the image files containing images already checked by the user at once from the memory section based on the check information.

Accordingly, the user can readily erase checked, unnecessary image files stored in the memory section by a simple input operation, for example, by pressing an erase all key (function key) provided on a manipulation section over the display section. This prevents, in a more reliable manner, the problem that the user forgets to erase the unnecessary image files and leaves too many image files in the memory section without being erased, to receive additional incoming data.

The facsimile device in accordance with the present invention is characterized in that it includes an image receiver section (image receiving means) receiving image files by facsimile transmission, and an image file managing device in accordance with the present invention managing the image files received by the image receiver section.

According to the foregoing structure, the facsimile device includes an image file managing device which manages image files received by the image receiver section transmitted by facsimile and stored in the memory section, each image file containing image data and comment data. The image file managing device includes: a check determining section which determines whether an image in the image data has been checked by the user; and an information recording section which records as additional information in the comment data, check information indicative of whether the image has been checked by the user based on a determination made by the check determining section.

Accordingly, the image file alone, without a dedicated file for the check information, enables a determination as to whether the particular image(s) has (have) been checked. This eliminates the problem of a dedicated file for management information, etc., which would result in an increased amount of data.

The facsimile device in accordance with the present invention is suitable for use even when, for example, the image files received by the facsimile device including the image file managing device in accordance with the present invention are copied, moved, or otherwise transferred to an information communications terminal other than the image file managing device (personal computer, one of various storage media, etc.) for management.

By recording the check information within each image file, it is possible to manage the check information and the image data in a single file. This eliminates the need for the management, etc. of links between the image files and the check information (which would be essential if the check information was managed as a standalone file separated from the image files) even when the image files are transferred to an information communications terminal other than the image file managing device in accordance with the present invention for management. As a result, the image files can be managed in more efficient manner.

Furthermore, the image file managing method in accordance with the present invention, as described in the foregoing, is characterized in that it is an image file managing method which manages image files stored in a memory section, each image file containing image data and comment data, and it includes the steps of: (1) determining whether a user has checked an image reproduced from the image data; and (2) recording check information as additional information in the comment data, check information indicative of whether the image has been checked by the user based on a determination made in the step (1).

According to the method, the image files alone, without a dedicated file for the check information, enables a determination as to whether the image has been checked by the user. This eliminates the problem of a dedicated file for management information, etc., which would result in an increased amount of data.

The image file managing device in accordance with the present invention is especially suitable for use when, for example, the image files as received are copied or transferred to an information communications terminal other than the image file managing device (personal computer, one of various storage media, etc.) for management.

By recording the check information within each image file, it is possible to manage the check information and the image data in a single file. This eliminates the need for the management, etc. of links between the image files and the check information (which would be essential if the check information was managed as a standalone file separated from the image files) even when the image files are transferred to an information communications terminal other than the image file managing device in accordance with the present invention for management. As a result, the image files can be managed in more efficient manner.

The image file managing device may be implemented on a computer. When this is a case, the present invention encompasses a computer program for image file management, causing the computer to function as the sections (means) in the image file managing device to implement the image file managing device on the computer: and a computer-readable storage medium containing the computer program.

The embodiments and examples described in Detailed Description of the Invention are for illustrative purposes only and by no means limit the scope of the present invention. Variations are not to be regarded as a departure from the spirit and scope of the invention, and all such modifications as would be obvious to one skilled in the art are intended to be included within the scope of the claims below.

What is claimed is:

1. An image file managing device, which manages image files stored in storage means, each of said image files containing image data and comment data, comprising:
check determining means which determines whether an image in the image data has been checked by the user; and
check information recording means which records as additional information in the comment data, check information indicative of whether the image has been checked by the user, based on a determination made by said check determining means.

2. The image file managing device of claim 1, further comprising:
notification means which extracts the check information from each of the image files to notify the user of whether the image in each image file has been checked based on the check information.

3. The image file managing device of claim 1, further comprising:
batch erasing means which extracts the check information from each image file stored in said storage means and carries out a batch process of erasing from said storage means, all image files containing images already checked by the user based on the check information.

4. The image file managing device of claim 2, further comprising:
display means, which displays information,
wherein said notification means notifies the user of whether the image in each image file has been checked by displaying the check information on said display means.

5. The image file managing device of claim 1, further comprising:
display means which displays information,
wherein when said display means displays the image in the image data, the check determining means determines that the image in the image data has been checked by the user.

6. The image file managing device of claim 5, wherein:
each image file contains thumbnail data prepared by scaling down that image data; and
when a particular image selected from a list of thumbnail data displayed on the display means is scaled up for display, the check determining means determines that the image has been checked by the user.

7. The image file managing device of claim 2, further comprising
print means, which prints information,
wherein said notification means notifies the user of whether the image in each image file has been checked by printing out the check information.

8. The image file managing device of claim 1, further comprising:
print means, which prints information,
wherein when the print means prints the image in the image data, the check determining means determines that the image in the image data has been checked by the user.

9. A facsimile device, comprising:
image receiving means which receives image files transmitted by facsimile; and
an image file-managing device, which manages the image, files received by said image receiving means and stored in storage means, each of said image files containing image data and comment data,
said image file managing device, comprising:
check determining means which determines whether an image in the image data has been checked by the user; and
check information recording means which records as additional information in the comment data, check information indicative of whether the image has been checked by the user, based on a determination made by said check determining means.

10. The facsimile device of claim 9, further comprising:
notification means, which extracts the check information from each of the image files to notify the user of whether the image in each image file has been checked based on the check information.

11. The facsimile device of claim 9, further comprising:
batch erasing means which extracts the check information from each image file stored in said storage means and carries out a batch process of erasing from said storage means, all image files containing images already checked by the user based on the check information.

12. The facsimile device of claim 10, further comprising:
display means, which displays information,
display means, which displays information,
wherein said notification means notifies the user of whether the image in each image file has been checked by displaying the check information on said display means.

13. The facsimile device of claim 9, further comprising:
display means, which displays information,
wherein when said display means displays the image in the image data, the check determining means determines that the image in the image data has been checked by the user.

14. The facsimile device of claim 13, wherein:
each image file contains thumbnail data prepared by scaling down that image data; and
when a particular image selected from a list of thumbnail data displayed on the display means is scaled up for display, the check determining means determines that the image has been checked by the user.

15. The facsimile device of claim 10, further comprising:
print means, which prints out information,
wherein said notification means notifies the user of whether the image in each image file has been checked by printing out the check information.

16. The facsimile device of claim 9, further comprising:
print means, which prints out information,
wherein when the print means prints out the image in the image data, the check determining means determines that the image in the image data has been checked by the user.

17. A method of managing image files, each containing image data and comment data, stored in storage means,
said method comprising the steps of:
(1) determining whether an image reproduced from the image data has been checked; and
(2) recording check information as additional information in the comment data, check information indicative of whether the image has been checked by the user based on a determination made in said step (1).

18. A computer program for managing image files, causing a computer to function as the respective means in the image file managing device of claim 1.

19. A computer-readable storage medium containing the computer program of claim 18.
